(19) United States
(12) Patent Application Publication
(10) Pub. No.: US 2009/0232355 A1
(43) Pub. Date: Sep. 17, 2009

(54) REGISTRATION OF 3D POINT CLOUD DATA USING EIGENANALYSIS

(75) Inventors: Kathleen Minear, Palm Bay, FL (US); Steven G. Blask, Melbourne, FL (US); Katie Gluvna, Palm Bay, FL (US)

Correspondence Address: HARRIS CORPORATION;C/O DARBY & DARBY PC, P.O. BOX 770, CHURCH STREET STATION, NEW YORK, NY, 10008-0770, US

(73) Assignee: Harris Corporation, Melbourne, FL (US)

(21) Appl. No.: 12/047,066

(22) Filed: Mar. 12, 2008

(51) Int. Cl. G06K 9/00

(52) U.S. Cl. 382/103

(57) ABSTRACT

Method (300) for registration of n frames 3D point cloud data. Frame pairs (200i, 200j) are selected from among the n frames and sub-volumes (702) within each frame are defined. Qualifying sub-volumes are identified in which the 3D point cloud data has a blob-like structure. A location of a centroid associated with each of the blob-like objects is also determined. Correspondence points between frame pairs are determined using the locations of the centroids in corresponding sub-volumes of different frames. Thereafter, the correspondence points are used to simultaneously calculate for all n frames, global translation and rotation vectors for registering all points in each frame. Data points in the n frames are then transformed using the global translation and rotation vectors to provide a set of n coarsely adjusted frames.

### BACKGROUND OF THE INVENTION

1. Statement of the Technical Field

The inventive arrangements concern registration of point cloud data, and more particularly registration of point cloud data for targets in the open and under significant occlusion.

2. Description of the Related Art

One problem that frequently arises with imaging systems is that targets may be partially obscured by other objects which prevent the sensor from properly illuminating and imaging the target. For example, in the case of an optical type imaging system, targets can be occluded by foliage or camouflage netting, thereby limiting the ability of a system to properly image the target. Still, it will be appreciated that objects that occlude a target are often somewhat porous. Foliage and camouflage netting are good examples of such porous occluders because they often include some openings through which light can pass.

It is known in the art that objects hidden behind porous occluders can be detected and recognized with the use of proper techniques. It will be appreciated that any instantaneous view of a target through an occluder will include only a fraction of the target's surface. This fractional area will be comprised of the fragments of the target which are visible through the porous areas of the occluder. The fragments of the target that are visible through such porous areas will vary depending on the particular location of the imaging sensor. However, by collecting data from several different sensor locations, an aggregation of data can be obtained. In many cases, the aggregation of the data can then be analyzed to reconstruct a recognizable image of the target. Usually this involves a registration process by which a sequence of image frames for a specific target taken from different sensor poses are corrected so that a single composite image can be constructed from the sequence.

In order to reconstruct an image of an occluded object, it is known to utilize a three-dimensional (3D) type sensing system. One example of a 3D type sensing system is a Light Detection And Ranging (LIDAR) system. LIDAR type 3D sensing systems generate image data by recording multiple range echoes from a single pulse of laser light to generate an image frame. Accordingly, each image frame of LIDAR data will be comprised of a collection of points in three dimensions (3D point cloud) which correspond to the multiple range echoes within sensor aperture. These points are sometimes referred to as “voxels” which represent a value on a regular grid in three dimensional space. Voxels used in 3D imaging are analogous to pixels used in the context of 2D imaging devices. These frames can be processed to reconstruct an image of a target as described above. In this regard, it should be understood that each point in the 3D point cloud has an individual x, y and z value, representing the actual surface within the scene in 3D.

Aggregation of LIDAR 3D point cloud data for targets partially visible across multiple views or frames can be useful for target identification, scene interpretation, and change detection. However, it will be appreciated that a registration process is required for assembling the multiple views or frames into a composite image that combines all of the data. The registration process aligns 3D point clouds from multiple scenes (frames) so that the observable fragments of the target represented by the 3D point cloud are combined together into a useful image. One method for registration and visualization of occluded targets using LIDAR data is described in U.S. Patent Publication 20050243323. However, the approach described in that reference requires data frames to be in close time-proximity to each other is therefore of limited usefulness where LIDAR is used to detect changes in targets occurring over a substantial period of time.

### SUMMARY OF THE INVENTION

The invention concerns a process for registration of a plurality of frames of three dimensional (3D) point cloud data concerning a target of interest. The process begins by acquiring a plurality of n frames, each containing 3D point cloud data collected for a selected geographic location. A number of frame pairs are defined from among the plurality of n frames. The frame pairs include both adjacent and non-adjacent frames in a series of the frames. Sub-volumes are thereafter defined within each of the frames. The sub-volumes are exclusively defined within a horizontal slice of the 3D point cloud data.

The process continues by identifying qualifying ones of the sub-volumes in which the 3D point cloud data has a blob-like structure. The identification of qualifying sub-volumes includes an Eigen analysis to determine if a particular sub-volume contains a blob-like structure. The identifying step also advantageously includes determining whether the sub-volume contains at least a predetermined number of data points.

Thereafter, a location of a centroid associated with each of the blob-like objects is determined. The locations of the centroids in corresponding sub-volumes of different frames are used to determine centroid correspondence points between frame pairs. The centroid correspondence points are determined by identifying a location of a first centroid in a qualifying sub-volume of a first frame of a frame pair, which most closely matches the location of a second centroid from the qualifying sub-volume of a second frame of a frame pair. According to one aspect of the invention, the centroid correspondence points are identified by using a conventional K-D tree search process.

The centroid correspondence points are subsequently used to simultaneously calculate for all n frames, global values of RⱼTⱼ for coarse registration of each frame, where Rⱼ is the rotation vector necessary for aligning or registering all points in each frame j to frame i, and Tⱼ is the translation vector for aligning or registering all points in frame j with frame i. The process then uses the rotation and translation vectors to transform all data points in the n frames using the global values of RⱼTⱼ to provide a set of n coarsely adjusted frames.

The invention further includes processing all the coarsely adjusted frames in a further registration step to provide a more precise registration of the 3D point cloud data in all frames. This step includes identifying correspondence points as between frames comprising each frame pair. The correspondence points are located by identifying data points in a qualifying sub-volume of a first frame of a frame pair, which most closely match the location of a second data point from the qualifying sub-volume of a second frame of a frame pair. For example, correspondence points can be identified by using a conventional K-D tree search process.

Once found, the correspondence points are used to simultaneously calculate for all n frames, global values of RⱼTⱼ for fine registration of each frame. Once again, Rⱼ is the rotation vector necessary for aligning or registering all points in each frame j to frame i, and Tⱼ is the translation vector for aligning or registering all points in frame j with frame i. All data points in the n frames are thereafter transformed using the global values of RⱼTⱼ to provide a set of n finely adjusted frames. The method further includes repeating the steps of identifying correspondence points, simultaneously calculating global values of RⱼTⱼ for fine registration of each frame, and transforming the data points until at least one optimization parameter has been satisfied.

### BRIEF DESCRIPTION OF THE DRAWINGS

FIG. 1 is a drawing that is useful for understanding why frames from different sensors (or the same sensor at different locations/rotations) require registration.

FIG. 2 shows an example of a set of frames containing point cloud data on which a registration process can be performed.

FIG. 3 is a flowchart of a registration process that is useful for understanding the invention.

FIG. 4 is a flowchart showing the detail of the coarse registration step in the flowchart of FIG. 3.

FIG. 5 is a flowchart showing the detail of the fine registration step in the flowchart of FIG. 3.

FIG. 6 is a chart that illustrates the use of a set of Eigen metrics to identify selected structures.

FIG. 7 is a drawing that is useful for understanding the concept of sub-volumes.

FIG. 8 is a drawing that is useful for understanding the concept of a voxel.

### DETAILED DESCRIPTION OF THE PREFERRED EMBODIMENTS

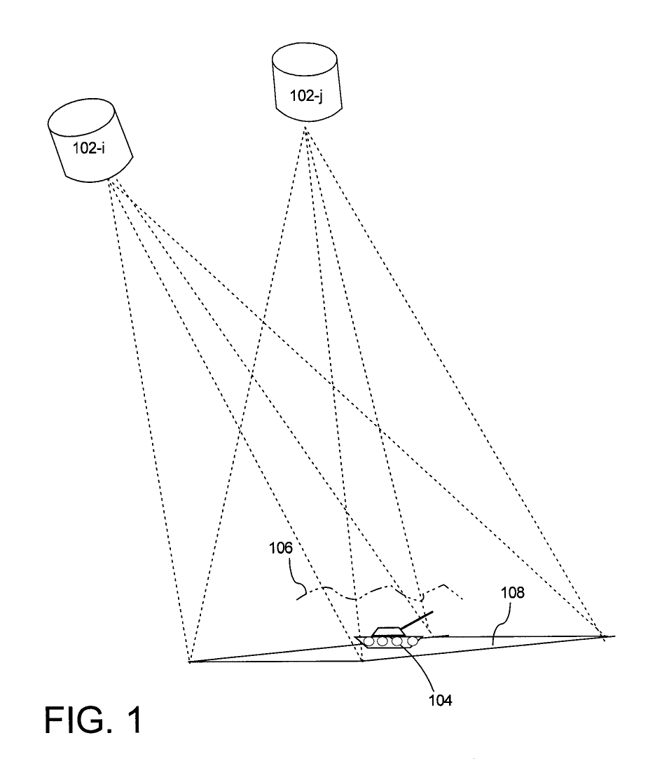

In order to understand the inventive arrangements for registration of a plurality of frames of three dimensional point cloud data, it is useful to first consider the nature of such data and the manner in which it is conventionally obtained. FIG. 1 shows sensors 102-i, 102-j at two different locations at some distance above a physical location 108. Sensors 102-i, 102-j can be physically different sensors of the same type, or they can represent the same sensor at two different times. Sensors 102-i, 102-j will each obtain at least one frame of three-dimensional (3D) point cloud data representative of the physical area 108. In general, the term point cloud data refers to digitized data defining an object in three dimensions.

For convenience in describing the present invention, the physical location 108 will be described as a geographic location on the surface of the earth. However, it will be appreciated by those skilled in the art that the inventive arrangements described herein can also be applied to registration of data from a sequence comprising a plurality of frames representing any object to be imaged in any imaging system. For example, such imaging systems can include robotic manufacturing processes, and space exploration systems.

Those skilled in the art will appreciate a variety of different types of sensors, measuring devices and imaging systems exist which can be used to generate 3D point cloud data. The present invention can be utilized for registration of 3D point cloud data obtained from any of these various types of imaging systems.

One example of a 3D imaging system that generates one or more frames of 3D point cloud data is a conventional LIDAR imaging system. In general, such LIDAR systems use a high-energy laser, optical detector, and timing circuitry to determine the distance to a target. In a conventional LIDAR system one or more laser pulses is used to illuminate a scene. Each pulse triggers a timing circuit that operates in conjunction with the detector array. In general, the system measures the time for each pixel of a pulse of light to transit a round-trip path from the laser to the target and back to the detector array. The reflected light from a target is detected in the detector array and its round-trip travel time is measured to determine the distance to a point on the target. The calculated range or distance information is obtained for a multitude of points comprising the target, thereby creating a 3D point cloud. The 3D point cloud can be used to render the 3-D shape of an object.

In FIG. 1, the physical volume 108 which is imaged by the sensors 102-i, 102-j can contain one or more objects or targets 104, such as a vehicle. However, the line of sight between the sensor 102-i, 102-j and the target may be partly obscured by occluding materials 106. The occluding materials can include any type of material that limits the ability of the sensor to acquire 3D point cloud data for the target of interest. In the case of a LIDAR system, the occluding material can be natural materials, such as foliage from trees, or man made materials, such as camouflage netting.

It should be appreciated that in many instances, the occluding material 106 will be somewhat porous in nature. Consequently, the sensors 102-I, 102-j will be able to detect fragments of the target which are visible through the porous areas of the occluding material. The fragments of the target that are visible through such porous areas will vary depending on the particular location of the sensor 102-i, 102j. However, by collecting data from several different sensor poses, an aggregation of data can be obtained. In many cases, the aggregation of the data can then be analyzed to reconstruct a recognizable image of the target.

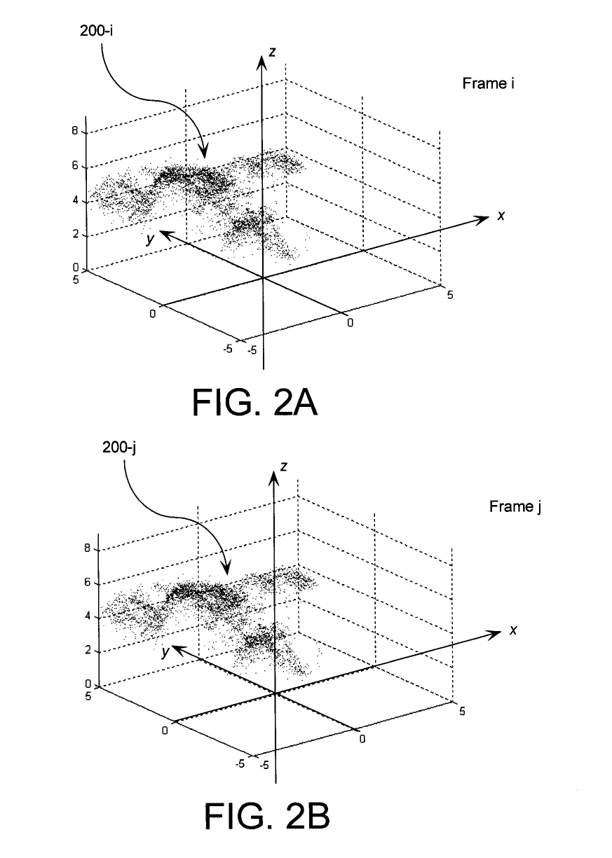

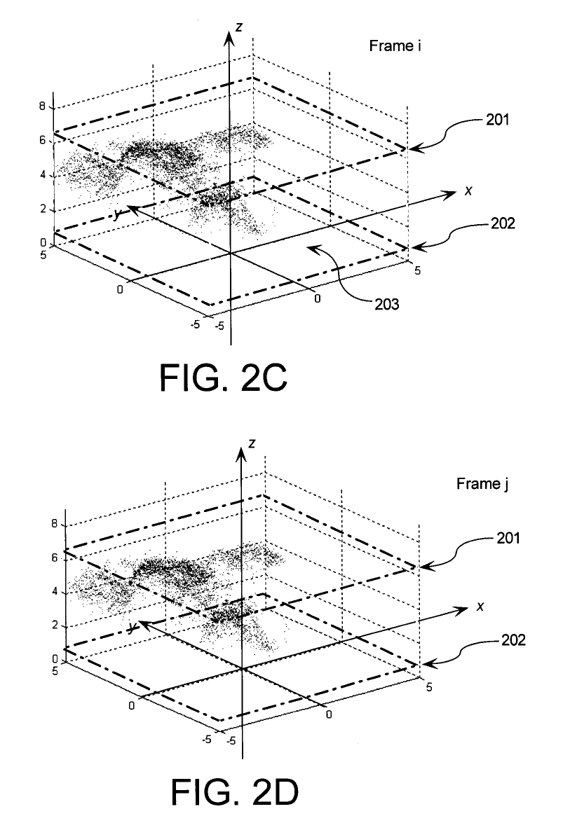

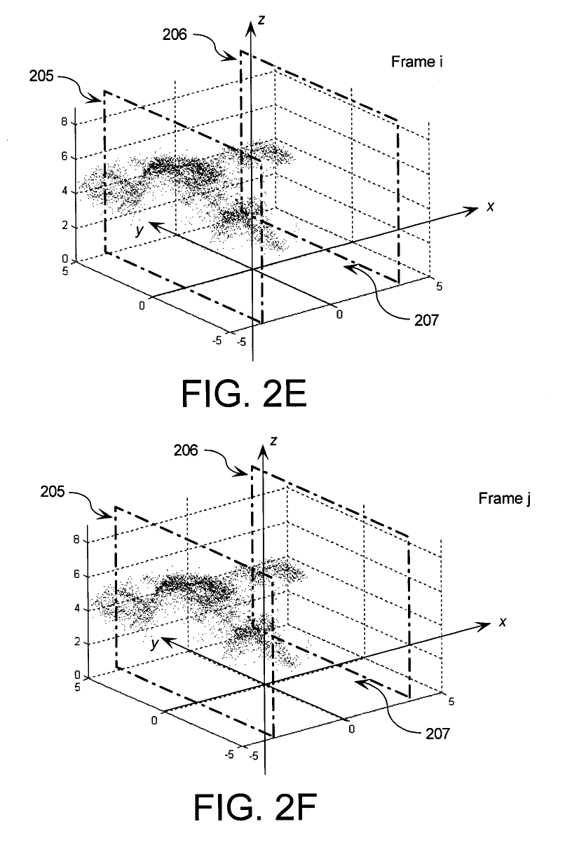

FIG. 2A is an example of a frame containing 3D point cloud data 200-i, which is obtained from a sensor 102-i in FIG. 1. Similarly, FIG. 2B is an example of a frame of 3D point cloud data 200-j, which is obtained from a sensor 102-j in FIG. 1. For convenience, the frames of 3D point cloud data in FIGS. 2A and 2B shall be respectively referred to herein as “frame i” and “frame j”. It can be observed in FIGS. 2A and 2B that the 3D point cloud data 200-i, 200-j each define the location of a set of data points in a volume, each of which can be defined in a three-dimensional space by a location on an x, y, and z axis. The measurements performed by the sensor 102-i, 102-j define the x, y, z location of each data point.

In FIG. 1, it will be appreciated that the sensor(s) 102-i, 102-j, can have respectively different locations and orientation. Those skilled in the art will appreciate that the location and orientation of the sensors 102-i, 102-j is sometimes referred to as the pose of such sensors. For example, the sensor 102-i can be said to have a pose that is defined by pose parameters at the moment that the 3D point cloud data 200-i comprising frame i was acquired.

From the foregoing, it will be understood that the 3D point cloud data 200-i, 200-j respectively contained in frames i, j will be based on different sensor-centered coordinate systems. Consequently, the 3D point cloud data in frames i and j generated by the sensors 102-i, 102-j, will be defined with respect to different coordinate systems. Those skilled in the art will appreciate that these different coordinate systems must be rotated and translated in space as needed before the 3D point cloud data from the two or more frames can be properly represented in a common coordinate system. In this regard, it should be understood that one goal of the registration process described herein is to utilize the 3D point cloud data from two or more frames to determine the relative rotation and translation of data points necessary for each frame in a sequence of frames.

It should also be noted that a sequence of frames of 3D point cloud data can only be registered if at least a portion of the 3D point cloud data in frame i and frame j is obtained based on common subject matter (i.e. the same physical or geographic area). Accordingly, at least a portion of frames i and j will generally include data from a common geographic area. For example, it is generally preferable for at least about ⅓ of each frame to contain data for a common geographic area, although the invention is not limited in this regard. Further, it should be understood that the data contained in frames i and j need not be obtained within a short period of time of each other. The registration process described herein can be used for 3D point cloud data contained in frames i and j that have been acquired weeks, months, or even years apart.

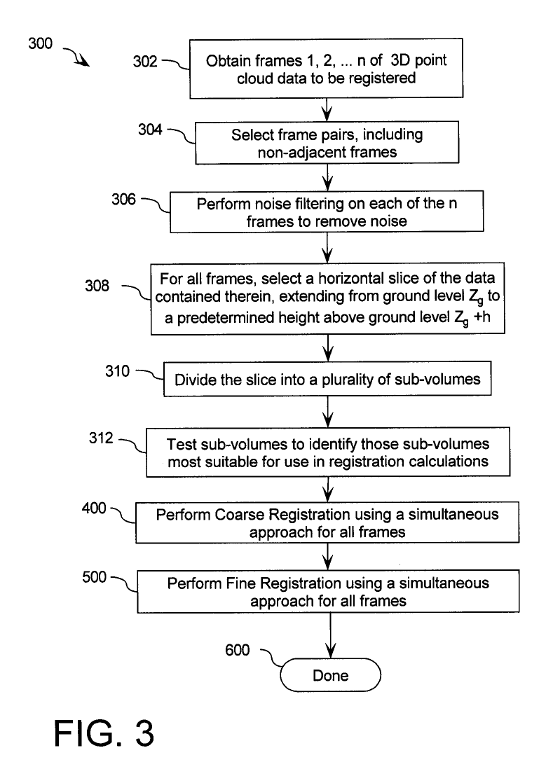

An overview of the process for registering a plurality of frames i, j of 3D point cloud data will now be described in reference to FIG. 3. The process begins in step 302. Steps 302 involves obtaining 3D point cloud data 200-i, . . . 200-n comprising a set of n frames. This step is performed using the techniques described above in relation to FIGS. 1 and 2. The exact method used for obtaining the 3D point cloud data for each of the n frames is not critical. All that is necessary is that the resulting frames contain data defining the location of each of a plurality of points in a volume, and that each point is defined by a set of coordinates corresponding to an x, y, and z axis. In a typical application, a sensor may collect 25 to 40 consecutive frames consisting of 3D measurements during a collection interval. Data from all of these frames can be aligned or registered using the process described in FIG. 3.

The process continues in step 304 in which a number of sets of frame pairs are selected. In this regard it should be understood that the term “pairs” as used herein does not refer merely to frames that are adjacent such as frame 1 and frame 2. Instead, pairs include adjacent and non-adjacent frames 1, 2; 1, 3; 1, 4; 2, 3; 2, 4; 2, 5 and so on. The number of sets of frame pairs determines how many pairs of frames will be analyzed relative to each individual frame for purposes of the registration process. For example, if the number of frame pair sets is chosen to be two (2), then the frame pairs would be 1, 2; 1, 3; 2, 3; 2, 4; 3, 4; 3, 5 and so on. If the number of frame pair sets is chosen to be three, then the frame pairs would instead be 1, 2; 1, 3; 1, 4; 2, 3; 2, 4; 2, 5; 3, 4; 3, 5; 3, 6; and so on.

A set of frames which have been generated sequentially over the course of a particular mission in which a specific geographic area is surveyed can be particularly advantageous in those instances when the target of interest is heavily occluded. That is because frames of sequentially collected 3D point cloud data are more likely to have a significant amount of common scene content from one frame to the next. This is generally the case where the frames of 3D point cloud data are collected rapidly and with minimal delay between frames. The exact rate of frame collection necessary to achieve substantial overlap between frames will depend on the speed of the platform from which the observations are made. Still, it should be understood that the techniques described herein can also be used in those instances where a plurality of frames of 3D point cloud data have not been obtained sequentially. In such cases, frame pairs of 3D point cloud data can be selected for purposes of registration by choosing frame pairs that have a substantial amount of common scene content as between the two frames. For example, a first frame and a second frame can be chosen as a frame pair if at least about 25% of the scene content from the first frame is common to the second frame.

The process continues in step 306 in which noise filtering is performed to reduce the presence of noise contained in each of the n frames of 3D point cloud data. Any suitable noise filter can be used for this purpose. For example, in one embodiment, a noise filter could be implemented that will eliminate data contained in those voxels which are very sparsely populated with data points. An example of such a noise filter is that described by U.S. Pat. No. 7,304,645. Still, the invention is not limited in this regard.

The process continues in step 308, which involves selecting, for each frame, a horizontal slice of the data contained therein. This concept is best understood with reference to FIGS. 2C and 2D which show planes 201, 202 forming horizontal slice 203 in frames i, j. This horizontal slice 203 is advantageously selected to be a volume that is believed likely to contain a target of interest and which excludes extraneous data which is not of interest. In one embodiment of the invention, the horizontal slice 203 for each frame 1 through n is selected to include locations which are slightly above the surface of the ground level and extending to some predetermined altitude or height above ground level. For example, a horizontal slice 203 containing data ranging from z=0.5 meters above ground-level, to z=6.5 meters above ground level, is usually sufficient to include most types of vehicles and other objects on the ground. Still, it should be understood that the invention is not limited in this regard. In other circumstances it can be desirable to choose a horizontal slice that begins at a higher elevation relative to the ground so that the registration is performed based on only the taller objects in a scene, such as tree trunks. For objects obscured under tree canopy, it is desirable to select the horizontal slice 203 that extends from the ground to just below the lower tree limbs.

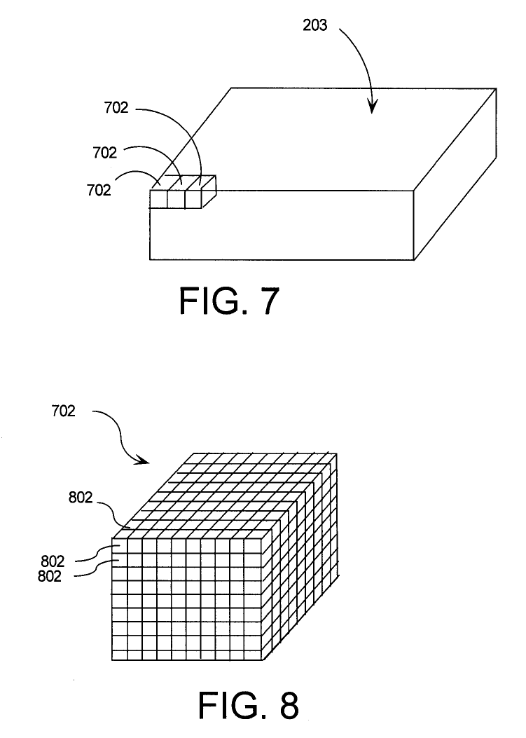

In step 310, the horizontal slice 203 of each frame is divided into a plurality of sub-volumes 702. This step is best understood with reference to FIG. 7. Individual sub-volumes 702 can be selected that are considerably smaller in total volume as compared to the entire volume represented by each frame of 3D point cloud data. For example, in one embodiment the volume comprising each of frames can be divided into 16 sub-volumes 702. The exact size of each sub-volume 702 can be selected based on the anticipated size of selected objects appearing within the scene. In general, however, it is preferred that each sub-volume have a size that is sufficiently large to contain blob-like objects that may be anticipated to be contained within the frame. This concept of blob-like objects is discussed in greater detail below. Still, the invention is not limited to any particular size with regard to sub-volumes 702. Referring again to FIG. 8, it can be observed that each sub-volume 702 is further divided into voxels. A voxel is a cube of scene data. For instance, a single voxel can have a size of (0.2 m)³.

Referring once again to FIG. 3, the process continues with step 312. In step 312 each sub-volume is evaluated to identify those that are most suitable for use in the calibration process. The evaluation process includes two tests. The first test involves a determination as to whether a particular sub-volume contains a sufficient number of data points. This test can be satisfied by any sub-volume that has a predetermined number of data points contained therein. For example, and without limitation, this test can include a determination as to whether the number of actual data points present within a particular sub-volume is at least 1/10^{th} of the total number of data points which can be present within the sub-volume. This process ensures that sub-volumes that are very sparsely populated with data points are not used for the subsequent registration steps.

The second test performed in step 312 involves a determination of whether the particular sub-volume contains a blob-like point cloud structure. In general, if a voxel meets the conditions of containing a sufficient number of data points, and has blob-like structure, then the particular sub-volume is deemed to be a qualifying sub-volume and is used in the subsequent registration processes.

Before continuing on, the meaning of the phrase blob or blob-like shall be described in further detail. A blob-like point cloud can be understood to be a three dimensional ball or mass having an amorphous shape. Accordingly, blob-like point clouds as referred to herein generally do not include point clouds which form a straight line, a curved line, or a plane. Any suitable technique can be used to evaluate whether a point-cloud has a blob-like structure. However, an Eigen analysis of the point cloud data is presently preferred for this purpose.

It is well known in the art that an Eigen analysis can be used to provide a summary of a data structure represented by a symmetrical matrix. In this case, the symmetrical matrix used to calculate each set of Eigen values is selected to be the point cloud data contained in each of the sub-volumes. Each of the point cloud data points in each sub-volume are defined by a x,y and z value. Consequently, an ellipsoid can be drawn around the data, and the ellipsoid can be defined by three 3 Eigen values, namely λ₁, λ₂, and λ₃. The first Eigen value λ₁ is always the largest and the third is always the smallest. Each Eigen value λ₁, λ₂, and λ₃ will have a value of between 0 and 1.0. The methods and techniques for calculating Eigen values are well known in the art. Accordingly, they will not be described here in detail.

In the present invention, the Eigen values λ₁, λ₂, and λ₃ are used for computation of a series of metrics which are useful for providing a measure of the shape formed by a 3D point cloud within a sub-volume. In particular, metrics M1, M2 and M3 are computed using the Eigen values λ₁, λ₂, and λ₃ as follows:

$$\begin{matrix}M 1 = \frac{{λ}_{3}}{\sqrt{{λ}_{2} {λ}_{1}}} & ( 1 ) \\ M 2 = {λ}_{1} / {λ}_{3} & ( 2 ) \\ M 3 = {λ}_{2} / {λ}_{1} & ( 3 )\end{matrix}$$

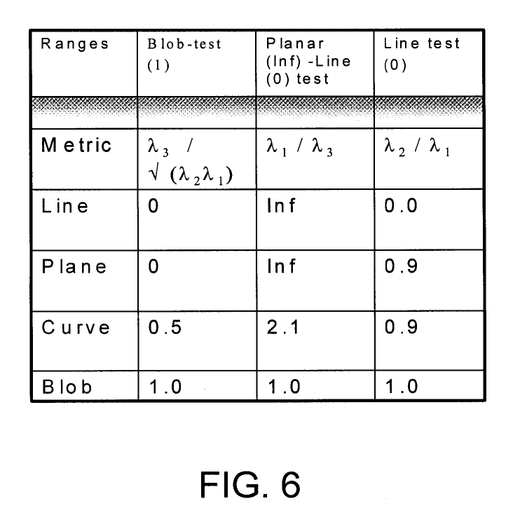

The table in FIG. 6 shows the three metrics M1, M2 and M3 that can be computed and shows how they can be used for identifying lines, planes, curves, and blob-like objects. As noted above, a blob-like point cloud can be understood to be a three dimensional ball or mass having an amorphous shape. Such blob-like point clouds can often be associated with the presence of tree trunks, rocks, or other relatively large stationary objects. Accordingly, blob-like point clouds as referred to herein generally do not include point clouds which merely form a straight line, a curved line, or a plane.

When the values of M1, M2 and M3 are all approximately equal to 1.0, this is an indication that the sub-volume contains a blob-like point cloud as opposed to a planar or line shaped point cloud. For example, when the value of M1, M2 and M3 for a particular sub-volume are each greater than 0.7, it can be said that the sub-volume contains a blob-like point cloud. Still, it should be understood that the invention is not limited to any specific value of M1, M2, M3 for purposes of defining a point-cloud having blob-like characteristics. Moreover, those skilled in the art will readily appreciate that the invention is not limited to the particular metrics shown. Instead, any other suitable metrics can be used, provided that they allow blob-like point clouds to be distinguished from point clouds that define straight lines, curved lines, and planes.

Referring once again to FIG. 3, the Eigen metrics in FIG. 6 are used in step 312 for identifying qualifying sub-volumes of a frame i . . . n which can be most advantageously used for the fine registration process. As used herein, the term “qualifying sub-volumes” refers to those sub-volumes that contain a predetermined number of data points (to avoid sparsely populated sub-volumes) and which contain a blob-like point cloud structure. The process is performed in step 312 for a plurality of frame pairs comprising both adjacent and non-adjacent scenes represented by a set of frames. For example, frame pairs can comprise frames 1, 2; 1, 3; 1, 4; 2, 3; 2, 4; 2, 5; 3, 4; 3, 5; 3, 6 and so on, where consecutively numbered frames are adjacent within a sequence of collected frames, and non-consecutively numbered frames are not adjacent within a sequence of collected frames.

Following the identification of qualifying sub-volumes in step 312, the process continues on to step 400. Step 400 is a coarse registration step in which a coarse registration of the data from frames 1 . . . n is performed using a simultaneous approach for all frames. More particularly, step 400 involves simultaneously calculating global values of RⱼTⱼ for all n frames of 3D point cloud data, where Rⱼ is the rotation vector necessary for coarsely aligning or registering all points in each frame j to frame i, and Tⱼ is the translation vector for coarsely aligning or registering all points in frame j with frame i.

Thereafter, the process continues on to step 500, in which a fine registration of the data from frames 1 . . . n is performed using a simultaneous approach for all frames. More particularly, step 500 involves simultaneously calculating global values of RⱼTⱼ for all n frames of 3D point cloud data, where Rⱼ is the rotation vector necessary for finely aligning or registering all points in each frame j to frame i, and Tⱼ is the translation vector for finely aligning or registering all points in frame j with frame i.

Notably, the coarse registration process in step 400 is based on a relatively rough adjustment scheme involving corresponding pairs of centroids for blob-like objects in frame pairs. As used herein, the term centroid refers to the approximate center of mass of the blob-like object. In contrast, the fine registration process in step 500 is a more precise approach that instead relies on identifying corresponding pairs of actual data points in frame pairs.

The calculated values for Rⱼ and Tⱼ for each frame as calculated in steps 400 and 500 are used to translate the point cloud data from each frame to a common coordinate system. For example, the common coordinate system can be the coordinate system of a particular reference frame i. At this point the registration process is complete for all frames in the sequence of frames. The process thereafter terminates in step 600 and the aggregated data from a sequence of frames can be displayed. Each of the coarse registration and fine registration steps are described below in greater detail.

Coarse Registration

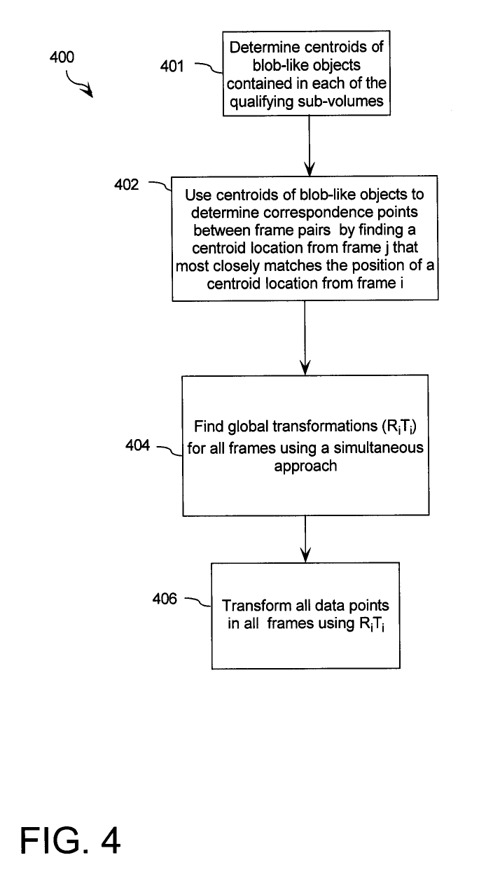

The coarse registration step 400 is illustrated in greater detail in the flowchart of FIG. 4. As shown in FIG. 4, the process continues with step 401 in which centroids are identified for each of the blob-like objects contained in each of the qualifying sub-volumes. In step 402, the centroids of blob-like objects for each sub-volume identified in step 312 are used to determine correspondence points between the frame pairs selected in step 304.

As used herein, the phrase “correspondence points” refers to specific physical locations in the real world that are represented in a sub-volume of frame i, that are equivalent to approximately the same physical location represented in a sub-volume of frame j. In the present invention, this process is performed by (1) finding a location of a centroid (centroid location) of a blob-like structure contained in a particular sub-volume from a frame i, and (2) determining a centroid location of a blob-like structure in a corresponding sub-volume of frame j that most closely matches the position of the centroid location of the blob-like structure from frame i. Stated differently, centroid locations in a qualifying sub-volume of one frame (e.g. frame j) are located that most closely match the position or location of a centroid location from the qualifying sub-volume of the other frame (e.g. frame i). The centroid locations from the qualifying sub-volumes are used to find correspondence points between frame pairs. Centroid location correspondence between frame pairs can be found using a K-D tree search method. This method, which is known in the art, is sometimes referred to as a nearest neighbor search method.

Notably, in the foregoing process of identifying correspondence points, it can be correctly assumed that corresponding sub-volumes do in fact contain corresponding blob-like objects. In this regard, it should be understood that the process of collecting each frame of point cloud data will generally also include collection of information concerning the position and altitude of a sensor used to collect such point cloud data. This position and altitude information is advantageously used to ensure that corresponding sub-volumes defined for two separate frames comprising a frame pair will in fact be roughly aligned so as to contain substantially the same scene content. Stated differently, this means that corresponding sub-volumes from two frames comprising a frame pair will contain scene content comprising the same physical location on earth. To further ensure that corresponding sub-volumes do in fact contain corresponding blob-like objects, it is advantageous to use a sensor for collecting 3D point cloud data that includes a selectively controlled pivoting lens. The pivoting lens can be automatically controlled such that it will remain directed toward a particular physical location even as the position of the vehicle on which the sensor is mounted approaches and moves away from the scene.

Once the foregoing correspondence points based on centroids of blob-like objects are determined for each frame pair, the process continues in step 404. In step 404, global transformations (RᵢTᵢ) are calculated for all frames, using a simultaneous approach. Step 400 involves simultaneously calculating global values of RⱼTⱼ for all n frames of 3D point cloud data, where Rⱼ is the rotation vector necessary for aligning or registering all points in each frame j to frame i, and Tⱼ is the translation vector for aligning or registering all points in frame j with frame 1.

Those skilled in the art will appreciate that there are a variety of conventional methods that can be used to perform a global transformation process as described herein. In this regard, it should be understood that any such technique can be used with the present invention. Such an approach can involve finding x, y and z transformations that best explain the positional relationships between the locations of the centroids in each frame pair. Such techniques are well known in the art. According to a preferred embodiment, one mathematical technique that can be applied to this problem of finding a global transformation of all frames simultaneously is described in a paper by J. A Williams and M. Bennamoun entitled “Simultaneous Registration of Multiple Point Sets Using Orthonormal Matrices” Proc., IEEE Int. Conf. on Acoustics, Speech and Signal Processing (ICASSP '00), the disclosure of which is incorporated herein by reference. Notably, it has been found that this technique can yield a satisfactory result directly, and without further optimization and iteration. Finally, in step 406 all data points in all frames are transformed using the values of RᵢTᵢ as calculated in step 406. The process thereafter continues on to the fine registration process described in relation to step 500.

Fine Registration

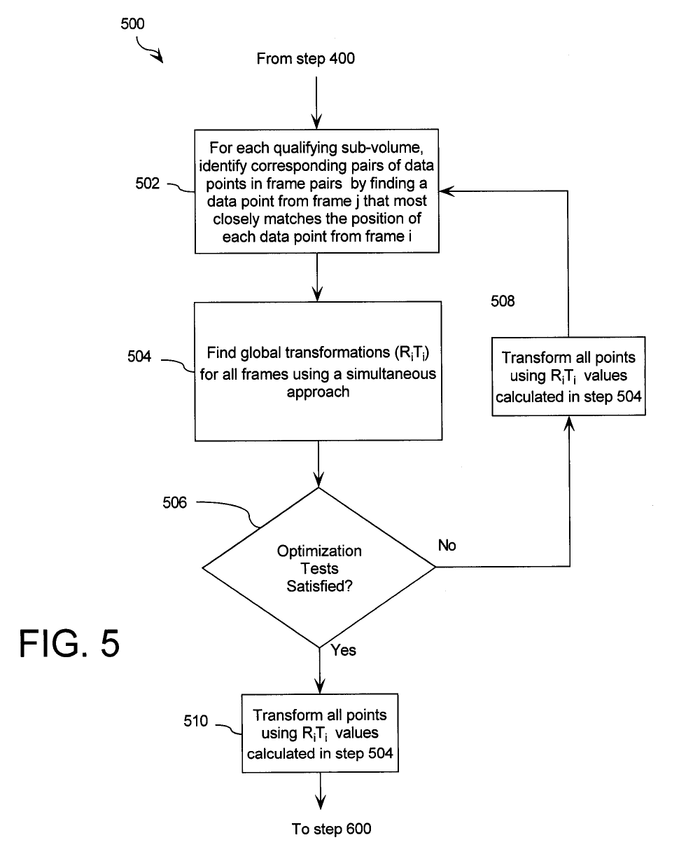

The coarse alignment performed in step 400 for each of the frames of 3D point cloud data is sufficient such that the corresponding sub-volumes from each frame can be expected to contain data points associated with corresponding structure or objects contained in a scene. As used herein, corresponding sub-volumes are those that have a common relative position within two different frames. Like the coarse registration process described in step 400 above, the fine registration process in step 500 also involves a simultaneous approach for registration of all frames at once. The fine registration process in step 500 is illustrated in further detail in the flowchart of FIG. 5.

More particularly, in step 500, all coarsely adjusted frame pairs from the coarse registration process in step 400 are processed simultaneously to provide a more precise registration. Step 500 involves simultaneously calculating global values of RⱼTⱼ for all n frames of 3D point cloud data, where Rⱼ is the rotation vector necessary for aligning or registering all points in each frame j to frame i, and Tⱼ is the translation vector for aligning or registering all points in frame j with frame i. The fine registration process in step 500 performs is based on corresponding pairs of actual data points in frame pairs. This is distinguishable from the coarse registration process in step 400 that is based on the less precise approach involving corresponding pairs of centroids for blob-like objects in frame pairs.

Those skilled in the art will appreciate that there are a variety of conventional methods that can be used to perform fine registration for each 3D point cloud frame pair, particularly after the coarse registration process described above has been completed. For example, a simple iterative approach can be used which involves a global optimization routine. Such an approach can involve finding x, y and z transformations that best explain the positional relationships between the data points in a frame pair comprising frame i and frame j after coarse registration has been completed. In this regard, the optimization routine can iterate between finding the various positional transformations of data points that explain the correspondence of points in a frame pair, and then finding the closest points given a particular iteration of a positional transformation.

For purposes of fine registration step 500, we again use the same qualifying sub-volumes have been selected for use with the coarse registration process described above. In step 502, the process continues by identifying, for each frame pair in the data set, corresponding pairs of data points that are contained within corresponding ones of the qualifying sub-volumes. This step is accomplished by finding data points in a qualifying sub-volume of one frame (e.g. frame j), that most closely match the position or location of data points from the qualifying sub-volume of the other frame (e.g. frame i). The raw data points from the qualifying sub-volumes are used to find correspondence points between each of the frame pairs. Point correspondence between frame pairs can be found using a K-D tree search method. This method, which is known in the art, is sometimes referred to as a nearest neighbor search method.

In step 504 and 506, the optimization routine is simultaneously performed on the 3D point cloud data associated with all of the frames. The optimization routine begins in step 504 by determining a global rotation, scale, and translation matrix applicable to all points and all frames in the data set. This determination can be performed using techniques described in the paper by J. Williams and M. Bennamoun entitled “Simultaneous Registration of Multiple Point Sets Using Orthonormal Matrices” Proc., IEEE Int. Conf. on Acoustics, Speech and Signal Processing (ICASSP '00). Consequently, a global transformation is achieved rather than merely a local frame to frame transformation.

The optimization routine continues in step 506 by performing one or more optimization tests. According to one embodiment of the invention, in step 506 three tests can be performed, namely a determination can be made: (1) whether a change in error is less than some predetermined value (2) whether the actual error is less than some predetermined value, and (3) whether the optimization process in FIG. 5 has iterated at least N times. If the answer to each of these test is no, then the process continues with step 508. In step 508, all points in all frames are transformed using values of RᵢTᵢ calculated in step 504. Thereafter, the process returns to step 502 for a further iteration.

Alternatively, if the answer to any of the tests performed in step 506 is “yes” then the process continues on to step 510 in which all frames are transformed using values of RᵢTᵢ calculated in step 504. At this point, the data from all frames is ready to be uploaded to a visual display. Accordingly, the process will thereafter terminate in step 600.

The optimization routine in FIG. 5 is used find a rotation and translation vector RᵢTᵢ for each frame j that simultaneously minimizes the error for all the corresponding pairs of data points identified in step 502. The rotation and translation vector is then used for all points in each frame j so that they can be combined with frame i to form a composite image. There are several optimization routines which are well known in the art that can be used for this purpose. For example, the optimization routine can involve a simultaneous perturbation stochastic approximation (SPSA). Other optimization methods which can be used include the Nelder Mead Simplex method, the Least-Squares Fit method, and the Quasi-Newton method. Still, the SPSA method is preferred for performing the optimization described herein. Each of these optimization techniques are known in the art and therefore will not be discussed here in detail.

A person skilled in the art will further appreciate that the present invention may be embodied as a data processing system or a computer program product. Accordingly, the present invention may take the form of an entirely hardware embodiment, an entirely software embodiment or an embodiment combining software and hardware aspects. The present invention may also take the form of a computer program product on a computer-usable storage medium having computer-usable program code embodied in the medium. Any suitable computer useable medium may be used, such as RAM, a disk driver, CD-ROM, hard disk, a magnetic storage device, and/or any other form of program bulk storage.

Computer program code for carrying out the present invention may be written in Java®, C++, or any other object orientated programming language. However, the computer programming code may also be written in conventional procedural programming languages, such as “C” programming language. The computer programming code may be written in a visually oriented programming language, such as VisualBasic.

All of the apparatus, methods and algorithms disclosed and claimed herein can be made and executed without undue experimentation in light of the present disclosure. While the invention has been described in terms of preferred embodiments, it will be apparent to those of skill in the art that variations may be applied to the apparatus, methods and sequence of steps of the method without departing from the concept, spirit and scope of the invention. More specifically, it will be apparent that certain components may be added to, combined with, or substituted for the components described herein while the same or similar results would be achieved. All such similar substitutes and modifications apparent to those skilled in the art are deemed to be within the spirit, scope and concept of the invention as defined.

We claim:

1. A method for registration of a plurality of frames of three dimensional (3D) point cloud data concerning a target of interest, comprising:
acquiring a plurality of n frames, each containing 3D point cloud data collected for a selected geographic location;
defining a plurality of frame pairs from among said plurality of n frames, said frame pairs comprising both adjacent and non-adjacent frames in a series of said frames;
defining a plurality of sub-volumes within each said frame of said plurality of frames;
identifying qualifying ones of said plurality of sub-volumes in which the 3D point cloud data has a blob-like structure;
determining a location of a centroid associated with each of said blob-like objects;
using the locations of said centroids in corresponding sub-volumes of different frames to determine centroid correspondence points between frame pairs;
using said centroid correspondence points to simultaneously calculate for all n frames, global values of RⱼTⱼ for coarse registration of each frame, where Rⱼ is the rotation vector necessary for aligning or registering all points in each frame j to frame i, and Tⱼ is the translation vector for aligning or registering all points in frame j with frame i;
transforming all data points in said n frames using said global values of RⱼTⱼ to provide a set of n coarsely adjusted frames.

2. The method according to claim 1, wherein said identifying step further comprises performing an Eigen analysis for each of said sub-volumes to determine if it contains a blob-like structure.

3. The method according to claim 1, wherein said identifying step further comprises determining whether said sub-volume contains at least a predetermined number of data points.

4. The method according to claim 1, further comprising, exclusively defining said plurality of sub-volumes within a horizontal slice of the 3D point cloud data.

5. The method according to claim 1, further comprising noise filtering each of said n frames to remove noise.

6. The method according to claim 1, wherein said step of determining centroid correspondence points further comprises identifying a location of a first centroid in a qualifying sub-volume of a first frame of a frame pair, which most closely matches the location of a second centroid from the qualifying sub-volume of a second frame of a frame pair.

7. The method according to claim 6, wherein said step of determining centroid correspondence points is performed by using a K-D tree search method.

8. The method according to claim 1, further comprising processing all said coarsely adjusted frames in a further registration step to provide a more precise registration of the 3D point cloud data in all frames.

9. The method according to claim 8, further comprising identifying correspondence points as between frames comprising each frame pair,

10. The method according to claim 9, wherein said identifying correspondence points step further comprises identifying data points in a qualifying sub-volume of a first frame of a frame pair, which most closely matches the location of a second data point from the qualifying sub-volume of a second frame of a frame pair.

11. The method according to claim 10, wherein said step of identifying correspondence points is performed using a K-D tree search method.

12. The method according to claim 10 further comprising using said correspondence points to simultaneously calculate for all n frames, global values of RⱼTⱼ for fine registration of each frame, where Rⱼ is the rotation vector necessary for aligning or registering all points in each frame j to frame i, and Tⱼ is the translation vector for aligning or registering all points in frame j with frame i.

13. The method according to claim 12, further comprising transforming all data points in said n frames using said global values of RⱼTⱼ to provide a set of n finely adjusted frames.

14. The method according to claim 13, further comprising repeating said steps of identifying correspondence points, simultaneously calculating global values of RⱼTⱼ for fine registration of each frame, and transforming step until at least one optimization parameter has been satisfied.

15. A method for registration of a plurality of frames of three dimensional (3D) point cloud data concerning a target of interest, comprising:
selecting a plurality of frame pairs from among said plurality of n frames containing 3D point cloud data for a scene;
defining a plurality of sub-volumes within each said frame of said plurality of frames;
identifying qualifying ones of said plurality of sub-volumes in which the 3D point cloud data comprises a pre-defined blob-like object;
determining a location of a centroid associated with each of said blob-like objects;
using the locations of said centroids in corresponding sub-volumes of different frames to determine centroid correspondence points between frame pairs;
using said centroid correspondence points to simultaneously calculate for all n frames, global values of RⱼTⱼ for coarse registration of each frame, where Rⱼ is the rotation vector necessary for aligning or registering all points in each frame j to frame i, and Tⱼ is the translation vector for aligning or registering all points in frame j with frame i.

16. The method according to claim 15, further comprising transforming all data points in said n frames using said global values of RⱼTⱼ to provide a set of n coarsely adjusted frames.

17. The method according to claim 16, wherein said identifying step further comprises performing an Eigen analysis for each of said sub-volumes to determine if it contains said pre-defined blob-like object.

18. The method according to claim 15, wherein said step of determining centroid correspondence points further comprises identifying a location of a first centroid in a qualifying sub-volume of a first frame of a frame pair, which most closely matches the location of a second centroid from the qualifying sub-volume of a second frame of a frame pair.

19. The method according to claim 15, further comprising processing all said coarsely adjusted frames in a further registration step to provide a more precise registration of the 3D point cloud data in all frames.

20. The method according to claim 19, further comprising identifying correspondence points as between frames comprising each frame pair,

21. The method according to claim 20, wherein said identifying correspondence points step further comprises identifying data points in a qualifying sub-volume of a first frame of a frame pair, which most closely matches the location of a second data point from the qualifying sub-volume of a second frame of a frame pair.

22. The method according to claim 21, wherein said step of identifying correspondence points is performed using a K-D tree search method.

23. The method according to claim 21 further comprising using said correspondence points to simultaneously calculate for all n frames, global values of RⱼTⱼ for fine registration of each frame, where Rⱼ is the rotation vector necessary for aligning or registering all points in each frame j to frame i, and Tⱼ is the translation vector for aligning or registering all points in frame j with frame i.

24. The method according to claim 15, further comprising noise filtering each of said n frames to remove noise.

25. A method for registration of a plurality of frames of three dimensional (3D) point cloud data concerning a target of interest, comprising:
acquiring a plurality of n frames, each containing 3D point cloud data collected for a selected geographic location;
performing filtering on each of said n frames to remove noise;
defining a plurality of frame pairs from among said plurality of n frames, said frame pairs comprising both adjacent and non-adjacent frames in a series of said frames;
defining a plurality of sub-volumes within each said frame of said plurality of frames;
identifying qualifying ones of said plurality of sub-volumes in which the 3D point cloud data has a blob-like structure;
determining a location of a centroid associated with each of said blob-like objects;
using the locations of said centroids in corresponding sub-volumes of different frames to determine centroid correspondence points between frame pairs;
using said centroid correspondence points to simultaneously calculate for all n frames, global values of RⱼTⱼ for coarse registration of each frame, where Rⱼ is the rotation vector necessary for aligning or registering all points in each frame j to frame i, and Tⱼ is the translation vector for aligning or registering all points in frame j with frame i;
transforming all data points in said n frames using said global values of RⱼTⱼ to provide a set of n coarsely adjusted frames.
